(19) United States
(12) Patent Application Publication
(10) Pub. No.: US 2019/0344847 A1
(43) Pub. Date: Nov. 14, 2019

(54) OVERHEAD CONVEYING DEVICE HAVING A VERTICALLY ARRANGED CONVEYING DEVICE

(71) Applicant: Torsten HÖSKER, Osterburken (DE)

(72) Inventor: Torsten HÖSKER, Osterburken (DE)

(21) Appl. No.: 16/475,218

(22) PCT Filed: Nov. 28, 2017
(86) PCT No.: PCT/EP2017/080641

§ 371 Date: Jul. 1, 2019

(30) Foreign Application Priority Data
Jan. 11, 2017 (DE) 10 2017 100 450.5

(51) Int. Cl. B62D 65/18; B65G 41/00

(52) U.S. Cl. CPC B62D 65/18; B65G 2201/0294; B65G 41/006

(57) ABSTRACT

The invention relates to an overhead conveying device (01) to be integrated in an assembly plant in order to transport vehicle components (02) by means of a conveying device (03) disposed on the overhead conveying device (01), said overhead conveying device having a supporting framework (06), said supporting framework (06) having a length of more than 5 m and a width of more than 2 m, and said conveying device (03) being mounted at the supporting framework (06), and said supporting framework (06) and said conveying device (03) limiting a conveying corridor (05), in which it is possible for the vehicle components (02) to be transported from an input point to an output point, and said supporting framework (06) being mounted, with the help of bearing means, on the floor (11) or on the ceiling of the assembly plant, and said bearing means giving rise to the formation, between the underside of the supporting framework (06) and the upper side of the floor (11), of a free space (12), which is suitable for component assembly and/or for component transport purposes and in which it is possible to walk and/or drive, said conveying device (03) extending vertically upwards at the supporting framework (06) starting from the fastening plane (04) and laterally limiting the conveying corridor (05) on one side, said vehicle components (02) being transported in the conveying corridor (05) in a manner projecting laterally from the conveying device (03), and said conveying device (03) being fixed at the supporting framework (06) on the upper side of the fastening plane (04) with the help of fastening means, and said supporting framework (06) being formed by a truss that comprises interconnected supporting beam elements (13, 14, 15) that are longitudinally oriented and interconnected supporting beam elements (13, 14, 15) that are transversely oriented and interconnected supporting beam elements (13, 14, 15) that diagonally run in between.

The invention relates to an overhead conveying device for integration in an assembly plant, which is suitable for transporting vehicle components, according to the preamble of claim 1.

In assembly plants for manufacturing vehicles, different types of conveying devices as well as of overhead conveying devices are employed. Based on the fact that assembly plants are individually adjusted to each type of vehicle to be manufactured and that the conveying devices are correspondingly configured, the overhead conveying devices employed in each instance are individually designed and manufactured. Here, an overhead conveying device of the type at hand relates to those conveying devices below which at least enough free movement space remains to allow a person to freely walk below them. Usually, free headroom of at least 2.5 m or more is the aim so that forklift trucks or other transport vehicles are also able to cross below the overhead conveying device. Using this overhead conveying device hence has the advantage that additional assembly space is obtained. Standing on the floor, further conveying devices or other kinds of assembly devices, such as assembly robots, may be disposed underneath the overhead conveying device.

In the known overhead conveying devices, for conveying the vehicle components, conveying devices are known that extend horizontally above the conveying corridor, the vehicle components being configured to be hooked in below the conveying device and to be moved along the conveying corridor. This suspended conveyance of the vehicle components is very stable from a mechanical point of view. The conveying devices that are used for conveying the vehicle components and that extend horizontally can be mounted on the supporting framework in a simple manner with the help of lateral supports, which laterally limit the conveying corridor on both sides.

A disadvantage of these conveying devices that are disposed horizontally is that it requires great efforts to hook the vehicle components in and out, due to the suspended fastening below the conveying devices. Due to these relatively long process times for hooking the vehicle components in and out, the known conveying devices are relatively inflexible. In modern assembly plants, there is, however, increasing demand for further flexibilization of the conveying rate of vehicle components to be conveyed. The overhead conveying devices are supposed to be able to withdraw different vehicle components from corresponding depositories as quickly and flexibly as possible and to transport the same to points of use that are predetermined in each instance. Vice versa, specific vehicle components are also supposed to be put in storage as quickly as possible.

It is therefore the object of the present invention to propose an overhead conveying device whose conveying device allows for a very flexible introduction and withdrawal of vehicle components to be conveyed, at the same time having a mechanical stability that is high enough to guarantee a corresponding process safety due to the vibration resistance. Said object is attained by an overhead conveying device according to the teaching of claim 1.

Advantageous embodiments of the invention are the subject-matter of the dependent claims.

The overhead conveying device in accordance with the invention is initially based on the fundamental idea that for conveying the vehicle components, a conveying device is used that extends vertically upwards starting from a fastening plane of the supporting framework. Here, the conveying device that is oriented vertically upwards limits the conveying corridor on one side. The vehicle components to be conveyed are transported in the conveying corridor in a manner projecting laterally from the conveying device. The fact that the vehicle components to be conveyed are disposed in a manner projecting laterally allows for a very quick introduction or withdrawal of the vehicle components to be conveyed since the conveying corridor is accessible from one side and from above.

The fact that the vehicle components to be conveyed are disposed in a manner projecting laterally at the conveying device that extends vertically upwards, however, leads to a substantially higher mechanical load on the supporting framework since the vehicle components that project laterally provoke substantial torque acting on the structure that supports the conveying device. In order to be able to absorb these mechanical loads on the conveying device having the vehicle components that project laterally, it is envisaged in accordance with the invention that the fastening plane of the supporting framework is designed in the manner of a truss that comprises interconnected supporting beam elements that are longitudinally oriented and interconnected supporting beam elements that are transversely oriented and interconnected supporting beam elements that diagonally run in between. Due to this truss design, for one thing a structure having high mechanical strength is formed that is able to absorb, without any problem, the torques that are incurred during the laterally projecting transport of the vehicle components to be conveyed. At the same time, the truss is characterized in that it has a relatively low dead weight and thus, by its dead weight, does not put too much load on the other fastening structures of the overhead conveying device.

In which manner the supporting beam elements of the truss, which forms the fastening plane, are connected to one another is basically arbitrary. For example, the supporting beam elements can be screwed or riveted to one another. It is particularly advantageous if the supporting beam elements of the truss are connected to one another in a welded structure with the help of weld seams. This is because the supporting beam elements that are welded to one another obtain an extraordinarily high mechanical strength at relatively low costs of production.

Regarding a mechanical rigidity that is as high as possible of the truss which forms the fastening plane of the supporting framework, it is furthermore particularly advantageous if the supporting beam elements of the truss have a closed tubular cross-section. This is because such supporting beam elements having a closed tubular cross-section have a substantially higher rigidity in case of bending and torsional load than supporting beam elements having an open tubular cross-section.

In order to dissipate the forces that originate from the conveying devices, which transport the vehicle components, into the fastening plane that is located underneath, the truss that forms the fastening plane has to be connected mechanically to the conveying device. In accordance with a first preferred embodiment, it is envisaged that the conveying device is welded to the upper side of the truss hereunto.

As an alternative to welding the conveying device to the upper side of the truss, the conveying device can also be screwed to the upper side of the truss.

The fastening plane of the supporting framework that consists of a truss has to be mounted, with the help of bearing means, on the floor or on the ceiling of the assembly plant in order to secure the desired distance between the upper side of the floor and the underside of the supporting framework. Insofar as the supporting framework is supposed to be supported on the floor, it is particularly advantageous if column gantries are used for supporting the supporting framework in the desired height. Here, these column gantries are characterized in that at least two support columns are provided whose lower ends are affixed on the floor of the assembly plant. Additionally, such a column gantry comprises a transverse bridge that is affixed between the two support columns. The supporting framework, which is embodied as a truss, can then be placed onto this transverse bridge from the top. Using column gantries for supporting the supporting framework, which is embodied as a truss, allows for successively constructing the overhead conveying device from prefabricated components. When assembling the overhead conveying device, the column gantries can initially be positioned individually and fixed to the floor of the hall. Subsequently, the supporting framework can then be placed onto the transverse bridges of the column gantries in a preassembled form, whereunto suitable lifting vehicles can for instance be employed, such as a corresponding forklift truck. As a result, the assembly time for constructing the overhead conveying device can significantly be reduced. Moreover, the mechanical stability of the column gantries can be calculated very well. Because of this, it is not necessary to oversize the bearing means, which is otherwise common. The supporting framework, which has been placed onto the transverse bridges of the column gantry, can be easily oriented and aligned before being fastened.

Regarding the mechanical stability of the overhead conveying device, it is again particularly advantageous if the support columns and/or the transverse bridge of the column gantry are manufactured from tubular material having a closed tubular cross-section.

Insofar as it is required, for fixing the supporting framework in the overhead conveying device, in addition to at least one column gantry, at least one freestanding support pillar and/or at least one wall bracket and/or at least one freely suspended traction element can be provided on the overhead conveying device as another bearing means for mounting the supporting framework.

If the supporting framework, which is embodied as a truss, is not supposed to be mounted on the floor, but to be hung from the ceiling of the assembly plant, it is particularly advantageous if a fastening plane is provided between, on the one hand, the bearing means, which are fastened on the ceiling structure of the assembly plant, and, on the other hand, the supporting framework. Here, the fastening plane is characterized in that it is connected to the bearing means, on the one hand, and the supporting framework, on the other hand, in a load-transmitting fashion and is formed from criss-crossing flexurally stiff steel girders. Here, the steel girders of the fastening plane are connected to one another in a load-transmitting fashion at the points of intersection and form a grid of four-sided intermediate zones. By inserting the additional fastening plane composed of criss-crossing steel girders, it is achieved that the parts of the overhead conveying device that are affixed underneath have standardized transitions at which they can be fastened to the top in a load-transmitting fashion. The fastening plane having the steel girders is, for another thing, then again fastened on the ceiling of the assembly plant with the help of the bearing means, the exact mounting of the individual fastening points on the ceiling only being of little importance. In other words, this means that by inserting the additional fastening plane, a decoupling of the fastening points on the ceiling of the assembly plant on the one hand and of the fastening points of the supporting framework on the other hand is achieved. This in particular allows for prefabricating all components of the overhead conveying device without knowing the precise position of fastening points on the ceiling of the assembly plant. When assembling the overhead conveying device, bearing means are then initially affixed on the ceiling of the assembly plant and the fastening planes having the steel girders forming the fastening planes are afterwards fastened to the bearing means, for instance welded to the same. By way of the grid of the intermediate plane that is selected so as to be suitable for this purpose, it is achieved that the bearing means can be joined to the steel girders of the fastening plane without any problem. As soon as the fastening plane having the steel girders has then been fastened to the ceiling in a suspended fashion, the overhead conveying device having the conveying device and the supporting framework underneath can be fastened in a suspended fashion in a standardized form with defined fastening bridges.

In which manner the fastening plane is constructed is basically arbitrary. In accordance with a preferred embodiment, it is envisaged that the fastening plane comprises two layers, the first layer comprising several steel girders running in a parallel fashion relative to one another in the longitudinal direction, and the second layer comprising several steel girders running in a parallel fashion relative to one another, the steel girders of the first plane running in the transverse direction relative to the steel girders of the second plane. In particular, the steel girders of the adjacent planes can be disposed so as to run at an angle of 90° relative to one another so that a grid of rectangular intermediate zones is formed.

In order to facilitate the assembly of the overhead conveying device, it is particularly advantageous if the supporting framework is designed so as to be self-supporting and is configured to be transported in preassembled form. In this manner, the supporting framework can be preassembled at the manufacturer's site. The preassembled subcomponents of the supporting framework can then be transported to the user, for instance in a container. Constructing the plant at the user's site is substantially facilitated by the preassembled parts of the supporting framework.

Furthermore, it is particularly advantageous if a maintenance walkway is affixed at a longitudinal side of the conveying device in order to facilitate corresponding maintenance work in the overhead conveying device. The maintenance staff can then reach the corresponding points of the overhead conveying device along the maintenance walkways in a simple manner.

One embodiment of the invention is illustrated as an example in the drawing and will be explained in the following.

In the figures:

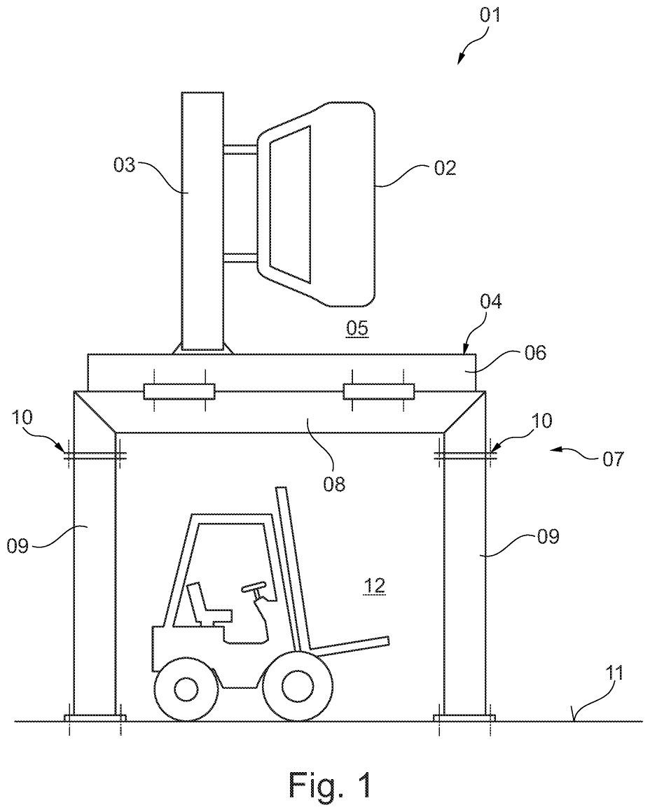

FIG. 1 shows an overhead conveying device in accordance with the invention in a schematized lateral view;

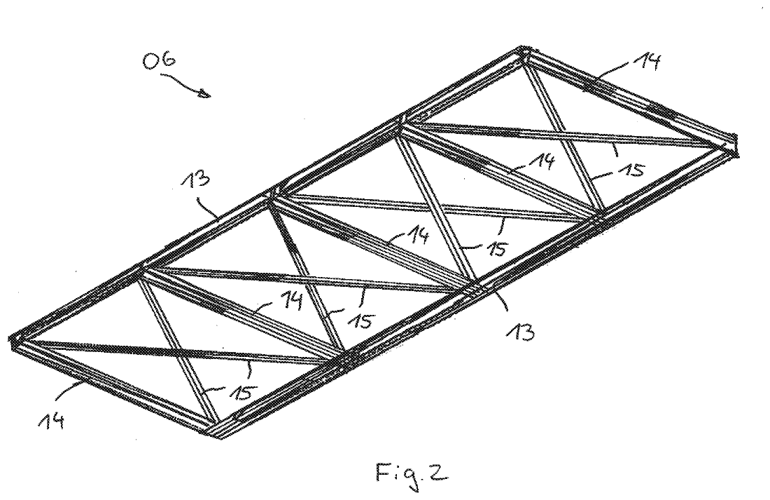

FIG. 2 shows the supporting framework that is comprised in the overhead conveying device and that is embodied as a truss in accordance with FIG. 1 in a perspective view from above.

FIG. 1 shows an overhead conveying device 01 in accordance with the invention in a lateral view. In other words, this means that the overhead conveying device 01 that is illustrated in FIG. 1 can extend in front of and behind the image plane in the conveying direction. A conveying device 03 serves for conveying vehicle components 02, for instance bodyshells, said conveying device 03 extending vertically upwards starting from a fastening plane 04. In this manner, the vehicle components 02 can laterally be hooked in at the conveying device 03 so that the vehicle components 02 laterally project into the conveying corridor 05. As a result, the conveying corridor 05 is freely accessible from the second side and from above so that the vehicle components 02 can be introduced and withdrawn very easily and very fast into and out of the conveying line that is formed by the conveying device 03.

The conveying device 03 is welded to the fastening plane 04 that is formed by a supporting framework 06 from the top in order to be able to dissipate the detent torques that are caused by the weight of the vehicle components 02 into the supporting structure that is located underneath in a manner in which largely no vibrations are transmitted. The supporting framework 06 is embodied in the manner of a truss and will subsequently be explained in more detail on the basis of the illustration in FIG. 2.

The supporting framework 06 is placed, from the top, onto multiple column gantries 07 that are disposed one behind the other, said supporting framework 06 being screwed to the transverse bridge 08 of the individual column gantries 07. Each column gantry 07 consists of a transverse bridge 08 and of two support columns 09 that support the transverse bridge 08 from below. The support columns 09 and the transverse bridge 08 that is fastened on the same are again screwed to one another at corresponding flanged connections 10. The lower end of the support columns 09 is fastened on the floor 11 with the help of suitable screw anchors. As a result, below the transverse bridges 08, a free space 12 is formed, which can be passed freely and is configured to receive, if necessary, corresponding assembly devices, such as assembly robots.

FIG. 2 shows the supporting framework 06 on whose upper side the conveying device 03 is fastened. The supporting framework 06 is embodied in the manner of a truss and comprises supporting beam elements 13 that are longitudinally oriented, supporting beam elements 14 that are transversely oriented and supporting beam elements 15 that diagonally run in between. All supporting beam elements 13, 14 and 15 of the supporting framework 06 are welded to one another and in this way form a highly rigid welded structure. Moreover, all supporting beam elements 13, 14 and 15 of the supporting framework 06 are manufactured from tubes having a closed tubular cross-section in order to thereby increase the rigidity of the supporting framework 06 again.

1. An overhead conveying device to be integrated in an assembly plant in order to transport vehicle components by means of a conveying device disposed on the overhead conveying device, said overhead conveying device having a supporting framework, said supporting framework having a length of more than 5 m and a width of more than 2 m, and said conveying device being mounted at the supporting framework and said supporting framework and said conveying device limiting a conveying corridor, in which it is possible for the vehicle components to be transported from an input point to an output point, and said supporting framework being mounted, with the help of bearing means, on the floor or on the ceiling of the assembly plant, and said bearing means giving rise to the formation, between the underside of the supporting framework and the upper side of the floor, of a free space, which is suitable for component assembly and/or for component transport purposes and in which it is possible to walk and/or drive,
wherein
the conveying device extends vertically upwards at the supporting framework starting from the fastening plane and laterally limits the conveying corridor on one side, said vehicle components being transported in the conveying corridor in a manner projecting laterally from the conveying device, and said conveying device being fixed at the supporting framework on the upper side of the fastening plane with the help of fastening means, and said supporting framework being formed by a truss that comprises interconnected supporting beam elements that are longitudinally oriented and interconnected supporting beam elements that are transversely oriented and interconnected supporting beam elements that diagonally run in between.

2. The overhead conveying device according to claim 1, wherein the supporting beam elements of the truss, which forms the supporting framework, are connected to one another in a welded structure.

3. The overhead conveying device according to claim 1, wherein the supporting beam elements of the truss, which forms the supporting framework, have a closed tubular cross-section.

4. The overhead conveying device according to claim 1, wherein the conveying device is welded to the upper side of the truss, which forms the supporting framework.

5. The overhead conveying device according to claim 1, wherein the conveying device is screwed to the upper side of the truss, which forms the supporting framework.

6. The overhead conveying device according to claim 1, wherein the supporting framework is mounted, with the help of bearing means, on the floor of the assembly plant, at least one bearing means being embodied in the manner of a column gantry, said column gantry comprising at least two support columns whose lower ends are affixed on the floor of the assembly plant, and at least one transverse bridge being affixed between two support columns in each instance, and said supporting framework being disposed on the upper side of the transverse bridge.

7. The overhead conveying device according to claim 6, wherein the support columns and/or the transverse bridge of the column gantry are manufactured from tubular material having a closed tubular cross-section.

8. The overhead conveying device according to claim 6, wherein in addition to at least one column gantry, at least one freestanding support pillar and/or at least one wall bracket and/or at least one freely suspended traction element is provided on the overhead conveying device as another bearing means for mounting the supporting framework.

9. The overhead conveying device according to claim 1, wherein the supporting framework is mounted, with the help of bearing means, on the ceiling of the assembly plant, a fastening plane being provided between, on the one hand, the bearing means, which are fastened on the ceiling structure of the assembly plant, and, on the other hand, the supporting framework, said fastening plane being connected in a load-transmitting fashion to the bearing means, on the one hand, and the supporting framework, on the other hand, and said fastening plane being formed from criss-crossing flexurally stiff steel girders, said steel girders being connected to one another in a load-transmitting fashion at the points of intersection, and said criss-crossing steel girders forming a grid of four-sided intermediate zones.

10. The overhead conveying device according to claim 9, wherein the fastening plane comprises two layers, the first layer comprising several steel girders running in a parallel fashion relative to one another in the longitudinal direction, and the second layer comprising several steel girders running in a parallel fashion relative to one another in the transverse direction.

11. The overhead conveying device according to claim 1, wherein the supporting framework is designed so as to be self-supporting and is configured to be transported in preassembled form.

12. The overhead conveying device according to claim 1, wherein a maintenance walkway is affixed at least along a longitudinal side of the conveying device.
